(19) United States
(12) Patent Application Publication
(10) Pub. No.: US 2022/0194566 A1
(43) Pub. Date: Jun. 23, 2022

(54) NOISE REDUCTION SYSTEM FOR AIR MOBILITY

(71) Applicants: Hyundai Motor Company, Seoul (KR); Kia Corporation, Seoul (KR)

(72) Inventors: Hee Kwang LEE, Suwon-si (KR); Hyun Seok Hong, Seoul (KR); Hyun Ki Cho, Anyang-si (KR)

(73) Assignees: Hyundai Motor Company, Seoul (KR); Kia Corporation, Seoul (KR)

(21) Appl. No.: 17/378,444

(22) Filed: Jul. 16, 2021

(30) Foreign Application Priority Data
Dec. 21, 2020 (KR) 10-2020-0179537

(51) Int. Cl. B64C 27/00; B64D 27/24; B64D 31/00

(52) U.S. Cl. CPC B64C 27/001; B64D 27/24; H02P 5/74; B64C 2027/003; B64D 31/00

(57) ABSTRACT

A noise reduction system for air mobility, may include a plurality of propeller modules provided on the air mobility and each including an inverter, a motor electrically connected to the inverter, and a propeller mounted to the motor; and a control unit configured to perform PWM control of power to be provided to the inverters to reduce noise attributable to carrier frequencies generated by the plurality of inverters or reduce noise attributable to fundamental frequencies generated by the plurality of motors.

### CROSS REFERENCE TO RELATED APPLICATION

The present application claims priority to Korean Patent Application No. 10-2020-0179537 filed on Dec. 21, 2020, the entire contents of which is incorporated herein for all purposes by this reference.

### BACKGROUND OF THE INVENTION

### Field of the Invention

The present invention relates to a noise reduction system for air mobility, and particularly, to a noise reduction system for air mobility, which reduces various types of noise that occur while air mobility operates a propeller to fly.

### Description of Related Art

Recently, air mobility, which may be used in various fields such as freight containers and medical transportation, is being developed, and the air mobility having improved energy efficiency and has been developed and reached the stage of practical use.

The air mobility flies by operating propellers. Noise occurs when the air mobility operates the propellers. However, recently, with the development of technologies for reducing noise generated by the operation of the propellers, main noise is generated by other peripheral elements. Various types of noise occurring in the air mobility include high-frequency switching noise of an inverter, and there is a demand for a technology for efficiently reducing noise because respective components make different levels of noise in various types of situations in which the air mobility maneuvers.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a noise reduction system for air mobility, which efficiently reduces various types of noise that occur when the air mobility operates a propeller.

In one aspect, a noise reduction system for air mobility includes: a plurality of propeller modules provided on the air mobility and each including an inverter, a motor electrically connected to the inverter, and a propeller mounted to the motor; and a control unit configured to perform PWM control of power to be provided to the inverters to reduce noise attributable to carrier frequencies generated by the plurality of inverters or reduce noise attributable to fundamental frequencies generated by the plurality of motors.

The noise reduction system may further include: a noise sensing unit provided on the air mobility and configured to detect noise generated by the propeller module, in which the control unit filters the noise, detected by the noise sensing unit, into the carrier frequency and the fundamental frequency.

The control unit may adjust the carrier frequencies generated by the inverters of the propeller modules disposed at a front side and a rear side in a wing of the air mobility among the plurality of propeller modules to reduce the noise attributable to the carrier frequency.

The control unit may derive a phase difference value for reducing the noise by offsetting wavelengths of the carrier frequencies of the inverters of the propeller modules disposed at the front side and the rear side of the wing.

The control unit may determine the phase difference value by use of a remainder value left when a distance between the inverters of the propeller modules disposed at the front side and the rear side in a wing of the air mobility is divided by a wavelength of the carrier frequency.

The control unit may reduce the noise attributable to the carrier frequency, when the air mobility flies.

The noise reduction system may further include: an object sensing unit provided on the air mobility and configured to detect a position of an object adjacent to the air mobility, in which the control unit performs the PWM control of power to be provided to the inverters to reduce the noise attributable to the fundamental frequency and transmitted to the object adjacent to the air mobility.

The control unit may reduce the noise attributable to the fundamental frequencies generated by the motors of the propeller modules disposed adjacent to the object among the plurality of propeller modules.

The control unit may group at least two propeller modules disposed adjacent to the object and derive a phase difference value for reducing the noise by offsetting wavelengths of the fundamental frequencies of the motors of the grouped at least two propeller modules.

The control unit may determine the phase difference value by use of remainder values left when distances between the object and the respective motors of the grouped at least two propeller modules are each divided by a wavelength of the fundamental frequency.

The control unit may reduce the noise attributable to the fundamental frequency when the air mobility is placed on the ground.

The control unit may perform the PWM control of power to be provided to the inverters to further reduce noise attributable to shaft frequencies generated by the plurality of propellers.

The control unit may derive the shaft frequency by use of the fundamental frequency generated by the motor and the number of magnetic elements included in the motor.

The noise reduction system may further include: an object sensing unit provided on the air mobility and configured to detect an object at the periphery of the air mobility, in which the control unit reduces the noise attributable to the shaft frequency to be transmitted to the object adjacent to the air mobility.

The control unit may group at least two propeller modules disposed adjacent to the object and derive a phase difference value for reducing the noise by offsetting wavelengths of the shaft frequencies of the propellers of the grouped at least two propeller modules.

The control unit may determine the phase difference value by use of remainder values left when distances between the object and the respective propellers of the grouped propeller modules are each divided by the wavelength of the shaft frequency.

The control unit may reduce the noise attributable to the shaft frequency, when the air mobility is placed on the ground.

The noise reduction system for air mobility, which has the above-mentioned structure, effectively reduces various types of noise that occur while the inverter, the motor, and the propeller operate in the air mobility.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration view of a noise reduction system for air mobility according to various exemplary embodiments of the present invention.

FIG. 2 is a view exemplarily illustrating a propeller module of the noise reduction system for air mobility illustrated in FIG. 1.

FIG. 3 is a view for explaining a reduction in noise attributable to a carrier frequency.

FIG. 4 is a view for explaining a reduction in noise attributable to a fundamental frequency.

FIG. 5 is a view for explaining a reduction in noise attributable to a shaft frequency.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION OF THE PRESENT INVENTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a noise reduction system for air mobility according to various exemplary embodiments of the present invention will be described with reference to the accompanying drawings.

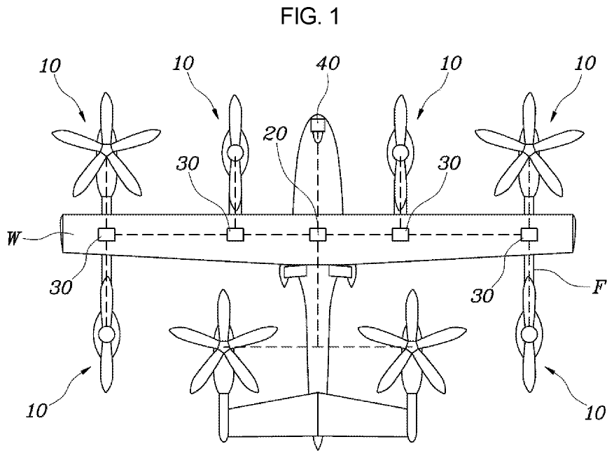

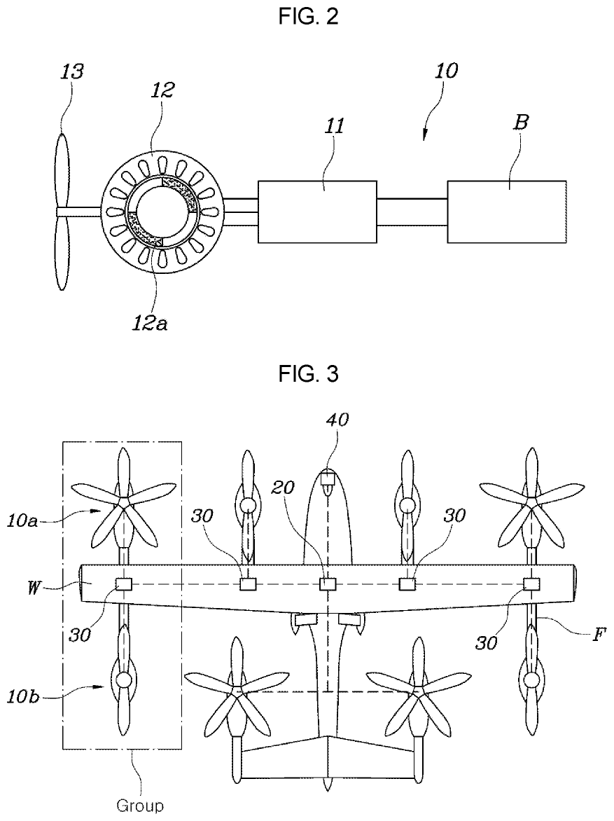

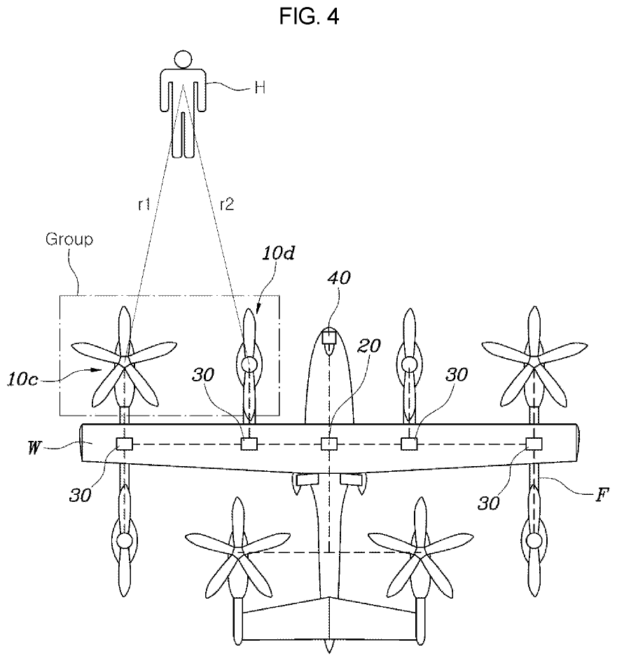

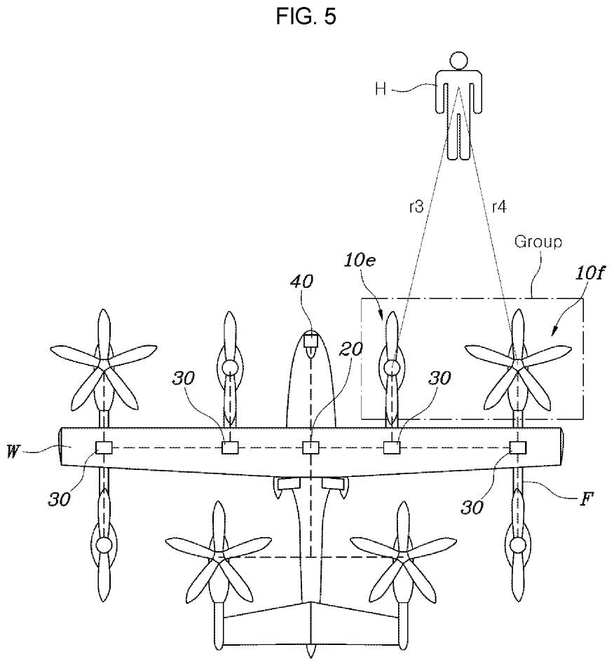

FIG. 1 is a configuration view of a noise reduction system for air mobility according to various exemplary embodiments of the present invention, FIG. 2 is a view exemplarily illustrating a propeller module of the noise reduction system for air mobility, illustrated in FIG. 1, FIG. 3 is a view for explaining a reduction in noise attributable to a carrier frequency, FIG. 4 is a view for explaining a reduction in noise attributable to a fundamental frequency, and FIG. 5 is a view for explaining a reduction in noise attributable to a shaft frequency.

As illustrated in FIGS. 1 to 2, the noise reduction system for air mobility according to various exemplary embodiments of the present invention includes a plurality of propeller modules 10 provided on air mobility A and each including an inverter 11, a motor 12, and a propeller 13; and a control unit 20 configured to perform pulse width modulation (PWM) control of power to be provided to the inverters 11 to reduce noise attributable to carrier frequencies generated by the plurality of inverters 11 or reduce noise attributable to fundamental frequencies generated by the plurality of motors 12.

The air mobility A has the plurality of propeller modules 10 for vertical take-off and landing or cruising flight, and each of the propeller modules 10 includes the inverter 11, the motor 12, and the propeller 13. Therefore, direct current power transmitted from a battery B is converted into alternating current power by the inverter 11 of the propeller module 10, and the motor 12 operates with the alternating current power to operate the propeller 13.

The control unit 20 performs the PWM control of power to be provided to the inverter 11. Therefore, the control unit 20 may have a phase controller configured for PWM control, and the control unit 20 may perform the PWM control by adjusting a duty ratio with the phase controller. Therefore, the control unit 20 may reduce noise attributable to carrier frequencies generated by the inverters 11 provided in the plurality of propeller modules 10 or reduce noise attributable to fundamental frequencies generated by the motors 12. That is, when the noise generated by the inverter 11 is loud, the control unit 20 may adjust a phase of the carrier frequency with the phase controller to reduce noise generated by the inverter 11. When the noise generated by the motor 12 or the propeller 13 is loud, the control unit 20 may adjust a phase of the fundamental frequency with the phase controller to reduce noise generated by the motor 12 or the propeller 13.

The present invention will be described specifically. The noise reduction system for air mobility according to various exemplary embodiments of the present invention further includes noise sensing units 30 configured to detect noise occurring in the propeller modules 10. The noise sensing unit 30 detects various types of noise occurring in the propeller module 10 and derives frequency wavelengths from the noise, and the noise detected by the noise sensing unit 30 may be filtered as the carrier frequency and the fundamental frequency by the phase controller. That is, the control unit 20 filters the noise, detected by the noise sensing unit 30, as the carrier frequency and the fundamental frequency with the phase controller and performs the PWM control based on a frequency having a larger wavelength between the carrier frequency and the fundamental frequency, reducing the corresponding noise.

In detail, to reduce the noise attributable to the carrier frequency, the control unit 20 may adjust the carrier frequencies, generated by the inverters 11 of the propeller modules 10 disposed at a front side and a rear side in a wing of the air mobility of each pod, among the plurality of propeller modules 10. If the propeller module 10 is provided at any one of the front side and the rear side in a wing of the air mobility of a pod F of the air mobility A, single noise removal may be performed on the corresponding propeller module 10.

As illustrated in FIG. 1, the air mobility A has a wing W, and the pods F for installing the propeller modules 10 are provided on the wing W. The pod F has a straight internal space so that the propeller module 10 may be provided. Therefore, to reduce the noise attributable to the carrier frequency, it is advantageous to reduce the noise of the inverters 11 of the propeller modules 10, disposed on one pod F to be spaced from each other in a forward/rearward direction thereof, among the plurality of propeller modules 10.

The noise sensing units 30 are provided between the propeller modules 10 disposed at the front side and the rear side in a wing of the air mobility of the pods F and detect the carrier frequencies and the fundamental frequencies generated by the propeller modules 10. Therefore, the number of noise sensing units 30 to be provided may be reduced, and efficient noise reduction control may be performed by measuring noise of the propeller modules 10 disposed at the front side and the rear side of the wing.

As illustrated in FIG. 3, to reduce the noise attributable to the carrier frequency, the control unit 20 may group the inverters 11 of the propeller modules 10 disposed at the front side and the rear side of the wing.

Therefore, the control unit 20 derives a phase difference value for reducing the noise by offsetting the wavelengths of the carrier frequencies of the inverters 11 of the propeller modules 10 disposed at the front side and the rear side of the wing.

The phase difference value refers to a phase difference for minimizing the noise attributable to the carrier frequency generated by the inverter 11 of a propeller module 10a disposed at the front side and the noise of each pod according to the carrier frequency generated by the inverter 11 of a propeller module 10b disposed at the rear side thereof.

To the present end, the control unit 20 may determine the phase difference value by use of a remainder value left when a distance between the inverters 11 of the propeller modules 10a and 10b disposed at the front side and the rear side in a wing of the air mobility of each pod is divided by the wavelength of the carrier frequency.

To derive the phase difference value, the control unit 20 may derive the remainder value left when the distance between the inverter 11 disposed at the front side and the inverter 11 disposed at the rear side by the wavelength of the carrier frequency of the inverter 11, and the control unit 20 may use the derived remainder value to determine the phase difference value for minimizing the noise attributable to the carrier frequency generated by the inverter 11 disposed at the front side and the noise attributable to the carrier frequency generated by the inverter 11 disposed at the rear side thereof.

The equation for deriving the phase difference value is as follows.

$$Phase Difference Value = π - \frac{{λ}_{1}}{{λ}_{carrierfrequency}} 2 π$$

In the instant case, λ₁ represents the remainder value, and λ_{carrier frequency} represents the carrier frequency of the inverter.

As described above, the control unit 20 may determine the phase difference value and adjust the wavelengths of the carrier frequencies generated by the inverters 11 of the propeller modules 10a and 10b disposed at the front and rear sides, minimizing the noise generated by the inverter 11.

The control for reducing the noise generated by the inverter 11 reduces the noise attributable to the carrier frequency when the air mobility A flies. That is, because the carrier frequency generated by the inverter 11 has a wider wavelength band than the fundamental frequency generated by the motor 12 or the propeller 13, the loud noise generated by the inverter 11 occurs in the interior of the flying air mobility A. Therefore, when the air mobility A flies, the control unit 20 reduces the noise attributable to the carrier frequency, thereby effectively reducing the noise occurring in the interior of the air mobility A.

The noise reduction system for air mobility according to various exemplary embodiments of the present invention may further include an object sensing unit 40 provided on the air mobility A and configured to detect a position of a person adjacent to the air mobility A. The object sensing unit 40 may include a radar sensor, a Light Detection and Ranging (LiDAR) sensor, or a camera sensor and detect various types of obstacles including persons at the periphery thereof.

The control unit 20 reduces the noise attributable to the fundamental frequency to be transmitted to the person adjacent to the air mobility A. That is, when the person is present at the periphery of the air mobility A, the loud noise, which is generated by the operation of the motor 12 or the propeller 13 of the propeller module 10, is transmitted to the person. Because intensity of sound is inversely proportional to a distance, the control unit needs to reduce the noise attributable to the fundamental frequency and transmitted to the person adjacent to the air mobility A.

Therefore, when the air mobility A is placed on the ground, the control unit 20 may reduce the noise attributable to the fundamental frequency. That is, the fundamental frequency generated by the motor 12 or the propeller 13 has a narrower wavelength band than the carrier frequency generated by the inverter 11, but the noise attributable to the fundamental frequency is transmitted over a longer distance. Because an occupant is positioned distant from the air mobility A when the air mobility A is placed on the ground and the occupant gets in or off the air mobility A, the occupant recognizes the louder noise generated by the motor 12 or the propeller 13. Therefore, the control unit 20 needs to reduce the noise attributable to the fundamental frequency when the air mobility A is placed on the ground.

In detail, the control unit 20 may reduce the noise attributable to the fundamental frequency generated by the motor 12 of the propeller module 10 disposed adjacent to the person among the plurality of propeller modules 10. Because the motor 12 of the air mobility A is provided to be exposed to the outside, the loud noise is generated by the motor 12. Therefore, the control unit 20 reduces the noise attributable to the fundamental frequency generated by the motor 12 of the propeller module 10 disposed adjacent to the person among the plurality of propeller modules 10, reducing the noise to be transmitted to the person.

As illustrated in FIG. 4, the control unit 20 groups at least two propeller modules 10c and 10d disposed adjacent to a person H and derives a phase difference value for reducing the noise by offsetting the wavelengths of the fundamental frequencies of the motors 12 of the grouped propeller modules 10c and 10d. Of course, the control unit 20 may adjust the fundamental frequencies of the motors 12 of the propeller modules 10, but in such a case, the control becomes complicated and control efficiency deteriorates. Therefore, the control unit 20 groups the at least two propeller modules 10c and 10d disposed adjacent to the person H and adjusts the fundamental frequencies of the grouped motors 12 by performing the PWM control of power to be provided to the inverters, simplifying the control and ensuring the control efficiency. In the instant case, the grouping of the propeller modules 10 may be determined in the order of distances between the respective motors 12 and the person H detected by the object sensing unit 40.

The control unit 20 may determine the phase difference value by use of remainder values left when the distances between the person and the respective motors 12 of the grouped propeller modules 10c and 10d are each divided by the wavelength of the fundamental frequency.

That is, the control unit 20 may determine the phase difference value by deriving the remainder values left when the respective distances between the person H and the motors 12 of the grouped propeller modules 10c and 10d are each divided by the wavelength of the fundamental frequency, and summing the remainder values. For example, when the person H is positioned in front of the air mobility A, the control unit 20 derives a remainder value by dividing a distance r1 between the person and the motor 12 of the propeller module 10c provided at one side, among the motors 12 of the grouped propeller modules 10c and 10d, by the wavelength of the fundamental frequency, and derives a remainder value by dividing a distance r2 between the person and the motor 12 of the propeller module 10d provided at the other side, among the motors 12 of the grouped propeller modules 10c and 10d, by the wavelength of the fundamental frequency. Thereafter, the control unit 20 may sum the derived remainder values to determine the phase difference value for reducing the noise by offsetting the wavelengths of the fundamental frequencies of the motors 12. That is, the control unit 20 may sum the remainder value obtained by dividing the distance between the person and the motor 12 of the propeller module 10c provided at one side by the fundamental frequency of the motor 12 and the remainder value obtained by dividing the distance between the person and the motor 12 of the propeller module 10d disposed at the other side by the fundamental frequency of the motor 12, and the control unit 20 may use a resultant value to determine the phase difference value for minimizing the noise attributable to the fundamental frequencies generated by the respective motors 12 of the propeller modules 10c and 10d provided at one side and the other side thereof.

The equation for deriving the phase difference value is as follows.

$$Phase Difference Value = π - \frac{{λ}_{2}}{{λ}_{fundamentalfrequency}} 2 π$$

In the instant case, λ₂ represents the summed remainder value, and λ_{fundamental} frequency represents the fundamental frequency of the motor.

Meanwhile, the control unit 20 may perform the PWM control of power to be provided to the inverters 11, further reducing noise generated by the shaft frequencies of the plurality of propellers 13. As described above, the control unit 20 adjusts the shaft frequency to reduce even the noise generated by the propeller 13 in addition to the noise generated by the inverter 11 and the motor 12 of the propeller module 10.

In the instant case, the control unit 20 may derive the shaft frequency by use of the fundamental frequency generated by the motor 12 and the number of magnetic elements 12a included in the motor 12. The fundamental frequency generated by the motor 12 may be detected and filtered by the noise sensing unit 30, and the magnetic elements 12a included in the motor 12 are predetermined in accordance with specifications of the motor 12. Therefore, the control unit 20 may derive the shaft frequency by multiplying the fundamental frequency generated by the motor 12 by the number of magnetic elements 12a included in the motor 12.

Meanwhile, the noise reduction system for air mobility according to various exemplary embodiments of the present invention may further include the object sensing unit 40 provided on the air mobility A and configured to detect a person positioned at the periphery of the air mobility A, and the control unit 20 reduces the noise attributable to the shaft frequency and transmitted to the person H adjacent to the air mobility A.

When it is determined that the person is detected by the object sensing unit 40, the control unit 20 reduces the noise attributable to the shaft frequency and transmitted to the person H adjacent to the air mobility A.

In detail, the control unit 20 may reduce the noise attributable to the shaft frequency generated by the propeller 13 of the propeller module 10, disposed adjacent to the person H, among the plurality of propeller modules 10. Because the propeller 13 of the air mobility A is exposed to the outside, the loud noise is generated by the propeller 13. Therefore, the control unit 20 reduces the noise attributable to the shaft frequency generated by the propeller 13, disposed adjacent to the person H, among the plurality of propeller modules 10, reducing the noise to be transmitted to the person.

As illustrated in FIG. 5, the control unit 20 groups at least two propeller modules 10e and 10f disposed adjacent to the person H and derives a phase difference value for reducing the noise by offsetting the wavelengths of the shaft frequencies of the propellers 13 of the grouped propeller modules 10e and 10f. Of course, the control unit 20 may adjust the shaft frequencies of the propellers 13 of the propeller modules 10, but in such a case, the control becomes complicated and control efficiency deteriorates. Therefore, the control unit 20 groups the at least two propeller modules 10e and 10f disposed adjacent to the person H and adjusts the shaft frequencies of the grouped propellers 13 by performing the PWM control of power to be provided to the inverters, simplifying the control and ensuring the control efficiency. In the instant case, the grouping of the propeller modules 10 may be determined in the order of distances between the respective propellers 13 and the person H detected by the object sensing unit 40.

The control unit 20 may determine the phase difference value by use of remainder values left when the distances between the person H and the respective propellers 13 of the grouped propeller modules 10e and 10f are each divided by the wavelength of the shaft frequency.

That is, the control unit 20 may determine the phase difference value by deriving the remainder values left when the distances between the person H and the respective propellers 13 of the grouped propeller modules 10e and 10f are each divided by the wavelength of the shaft frequency, and summing the remainder values. For example, when the person H is positioned in front of the air mobility A, the control unit derives a remainder value by dividing a distance r3 between the person and the propeller 13 of the propeller module 10e provided at one side, among the propellers 13 of the grouped propeller modules 10e and 10f, by the wavelength of the shaft frequency, and derives a remainder value by dividing a distance r4 between the person and the propeller 13 of the propeller module 10f provided at the other side, among the propellers 13 of the grouped propeller modules 10e and 10f, by the wavelength of the shaft frequency. Thereafter, the control unit 20 may sum the derived remainder values to determine the phase difference value for reducing the noise by offsetting the wavelengths of the shaft frequencies of the propellers 13. That is, the control unit 20 may sum the remainder value obtained by dividing the distance between the person and the propeller 13 of the propeller module 10e provided at one side by the shaft frequency and the remainder value obtained by dividing the distance between the person and the propeller 13 of the propeller module 10f provided at the other side by the shaft frequency, and the control unit 20 may use the summed remainder value to determine the phase difference value for minimizing the noise attributable to the shaft frequencies generated by the respective propellers 13 of the propeller modules 10e and 10f disposed at one side and the other side thereof.

The equation for deriving the phase difference value is as follows.

$$Phase Difference Value = π - \frac{{λ}_{3}}{{λ}_{shaftfrequency}} 2 π$$

In the instant case, λ₃ represents the summed remainder value, and λ_{shaft frequency} represents the shaft frequency of the propeller.

The noise reduction system for air mobility A, which has the above-mentioned structure, may effectively reduce the noise generated by the inverter 11, the motor 12, and the propeller 13 in the air mobility A. The present invention may selectively reduce the noise generated by the inverter 11, the motor 12, and the propeller 13 depending on whether the air mobility A is flying or placed on the ground. The present invention may reduce the loudest noise generated by one of the inverter 11, the motor 12, and the propeller 13. The occurrence of noise is minimized by efficiently reducing various types of noise generated in the air mobility A.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a control device, and the control device may be configured by multiple control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A noise reduction system for air mobility, the noise reduction system comprising:
a plurality of propeller modules provided on the air mobility and each including an inverter, a motor electrically connected to the inverter, and a propeller mounted to the motor; and
a control unit configured to perform pulse width modulation (PWM) control of power provided to the inverters to reduce noise caused by carrier frequencies generated by the inverters or reduce noise caused by fundamental frequencies generated by the motors.

2. The noise reduction system of claim 1, further including:
a noise sensing unit provided on the air mobility and configured to detect the noises generated by the plurality of propeller modules,
wherein the control unit is configured to filter noises detected by the noise sensing unit as the carrier frequencies and the fundamental frequencies.

3. The noise reduction system of claim 1, wherein the control unit is configured to adjust the carrier frequencies generated by inverters of propeller modules disposed at a front side and a rear side in a wing of the air mobility among the plurality of propeller modules to reduce the noise caused by the carrier frequencies.

4. The noise reduction system of claim 3, wherein the control unit is configured to derive a phase difference value for reducing the noise by offsetting wavelengths of the carrier frequencies of the inverters of the propeller modules disposed at the front side and the rear side of the wing.

5. The noise reduction system of claim 3, wherein the control unit is configured to determine the phase difference value by use of a remainder value left when a distance between the inverters of the propeller modules disposed at the front side and the rear side in the wing of the air mobility is divided by a wavelength of the carrier frequencies.

6. The noise reduction system of claim 2, wherein the control unit is configured to reduce the noise caused by the carrier frequencies when the air mobility flies.

7. The noise reduction system of claim 1, further including:
an object sensing unit provided on the air mobility and configured to detect a position of an object adjacent to the air mobility,
wherein the control unit is configured to selectively reduce the noise generated by the inverters, the motors, and the propellers depending on whether the air mobility is flying or placed on the ground or whether the object is adjacent to the air mobility.

8. The noise reduction system of claim 7,
wherein the control unit is configured to perform the PWM control of the power to be provided to the inverters to reduce the noise caused by the fundamental frequencies and transmitted to the object adjacent to the air mobility.

9. The noise reduction system of claim 7, wherein the control unit is configured to reduce the noise caused by the fundamental frequencies generated by motors of propeller modules disposed adjacent to the object among the plurality of propeller modules.

10. The noise reduction system of claim 7, wherein the control unit is configured to group at least two propeller modules disposed adjacent to the object among the plurality of propeller modules and to determine a phase difference value for reducing the noise by offsetting wavelengths of the fundamental frequencies of the motors of the grouped at least two propeller modules.

11. The noise reduction system of claim 10, wherein the control unit is configured to determine the phase difference value by use of remainder values left when distances between the object and the respective motors of the grouped at least two propeller modules are each divided by a wavelength of the fundamental frequencies.

12. The noise reduction system of claim 7, wherein the control unit is configured to reduce the noise caused by the fundamental frequencies of the motors or the propellers when the air mobility is placed on the ground.

13. The noise reduction system of claim 1, wherein the control unit is configured to perform the PWM control of power to be provided to the inverters to further reduce noise caused by shaft frequencies generated by the plurality of propellers.

14. The noise reduction system of claim 13, wherein the control unit is configured to derive the shaft frequencies by use of the fundamental frequencies generated by the motors and a number of magnetic elements included in each motor.

15. The noise reduction system of claim 13, further including:
an object sensing unit provided on the air mobility and configured to detect an object at a periphery of the air mobility,
wherein the control unit is configured to reduce the noise caused by the shaft frequencies and transmitted to the object adjacent to the air mobility.

16. The noise reduction system of claim 15, wherein the control unit is configured to group at least two propeller modules disposed adjacent to the object and derives a phase difference value for reducing the noise by offsetting wavelengths of the shaft frequencies of the propellers of the grouped at least two propeller modules.

17. The noise reduction system of claim 16, wherein the control unit is configured to determine the phase difference value by use of remainder values left when distances between the object and respective propellers of the grouped at least two propeller modules are each divided by the wavelengths of the shaft frequencies.

18. The noise reduction system of claim 13, wherein the control unit is configured to reduce the noise caused by the shaft frequencies when the air mobility is placed on the ground.
